(19) United States
(12) Patent Application Publication
(10) Pub. No.: US 2023/0040673 A1
(43) Pub. Date: Feb. 9, 2023

(54) OPTIMISED MACHINE LEARNING PROCESSING

(71) Applicant: Arm Limited, Cambridge (GB)

(72) Inventors: Daren CROXFORD, Swaffham Prior (GB); Sharjeel SAEED, Cambridge (GB); Rachel Jean TRIMBLE, Grindleford (GB)

(21) Appl. No.: 17/387,454

(22) Filed: Jul. 28, 2021

(51) Int. Cl. G06N 3/08; G06N 3/04; G06K 9/62

(52) U.S. Cl. CPC G06N 3/08; G06N 3/04; G06K 9/6202

(57) ABSTRACT

A method for optimizing machine learning processing is provided. The method comprising retrieving, neural network architecture information for a neural network, the neural network architecture information comprising layer information and kernel information for the neural network. The network architecture information is analyzed to identify convolutional layers in the neural network which have associated strided layers. A first kernel for a convolutional layer identified as having an associated strided layer, and a second kernel for the strided layer associated with the convolutional layer are retrieved. A composite kernel is then generated, based on the first and second kernel, that performs the functions of the first and second kernel. Finally, the composite kernel is stored for further use by a neural network.

### TECHNICAL FIELD

The present disclosure relates to systems, methods and apparatuses for optimizing machine learning processing. In particular, the present disclosure relates to optimizing the kernels used in processing layers of a neural network, such as a convolutional neural network.

### BACKGROUND

Neural networks, such as convolutional neural networks (CNNs) typically comprise a number of processing layers which can be broadly characterized as either Input Layers, Computational Layers or Output Layers. Each Computational Layer in the network receives input data, typically in the form of an Input Feature Map (IFM) from either an Input Layer or a preceding Computational Layer. Each Computational Layer processes the received input data and outputs processed data, typically in the form of an Output Feature Map (OFM), the output data being passed either to the next Computational Layer, or an Output Layer. Each Computational Layer processes the received input data with a layer-specific kernel (sometimes also referred to as a filter). The kernel may either be a pre-defined operator or a function created during training of the neural network.

Processors are used to execute such neural networks. In many cases specialized processors are used, such as neural processing units (NPUs) and other custom processors specifically adapted for neural network computations. It is also possible to use generalized processors to perform neural network computations, including central processing units (CPUs), graphical processing units (GPUs), digital signal processors (DSPs), etc. These processors may also have on-board storage, for example in the form of static random-access memory (SRAM). However, even with modern specialized processors, all but the very simplest of neural networks require significant processing resources (memory and computer resources) to implement, due to the size of the input data being processed and the complexity of the calculations being performed. These significant processing resources mean that it can take a reasonable amount of time to perform this type of processing, and the processing consumes a reasonable amount of energy.

Neural networks often include pooling layers which may be used to reduce the size of the processed feature maps in the subsequent layers of the network. Generally, neural networks start with a large data set and the data size “shrinks” as passes through the layers of the neural network until it is reduced in size sufficiently to be processed as fully connected. A further advantage of using pooling layers is that they may also reduce the processing complexity of the network through this reduction in the size of the feature maps being handled within the neural network.

In Machine Learning, “pooling” is a form of non-linear down sampling applied to data to reduce the spatial size of the data, reduce the number of parameters, reduce the memory footprint, and reduce the amount of further computation required in the network. To reduce the size of the feature map to which the pooling layer is applied, each pooling layer applies a matrix operator to a subset of the feature map, the operator is then “strided” across the feature map (consecutively applied across the whole feature map, in either an overlapping or non-overlapping manner), with the results of each operation being used to form a new pooled feature map. The cost of applying pooling is a reduction in the accuracy/resolution of the data passing through the network. However, given the significant computational advantages, this cost is often outweighed by the memory and compute benefits.

However, even with the inclusion of pooling layers, significant computational resources are still required to implement a typical neural network. It is therefore desirable to increase the efficiency of processing of data across the layers of a neural network, to enable quicker compute times and/or larger datasets to be handled for a given compute capacity.

### SUMMARY

According to a first aspect of the present disclosure, there is provided a method for optimizing machine learning processing, comprising retrieving, neural network architecture information for a neural network, the neural network architecture information comprising layer information and kernel information for the neural network; analyzing the network architecture information to identify convolutional layers in the neural network which have associated strided pooling layers; retrieving a first kernel for a convolutional layer identified as having an associated strided pooling layer; retrieving a second kernel for the strided pooling layer associated with the convolutional layer; generating a composite kernel, based on the first and second kernel, that performs the functions of the first and second kernel; and storing the composite kernel.

According to a second aspect of the present disclosure, there is provided a non-transitory computer-readable storage medium comprising a set of computer-readable instructions stored thereon, which when executed by at least one processor, cause the at least one processor to perform the steps of the first aspect.

According to a third aspect of the present disclosure, there is provided a neural network driver comprising: a processor; and memory storing computer readable instructions which, when implemented by the processor, cause the processor to perform the steps of the first aspect.

According to a fourth aspect of the present disclosure, there is provided a neural network comprising: a convolutional layer arranged to receive an input feature map and perform a first operation on the received input feature map; a strided pooling layer arranged to receive an output of the convolutional layer and perform a second operation on the received output; and a composite kernel, which, when used to process the input feature map received by the convolutional layer, performs both the first and second operation on the input feature map, thereby enabling the strided pooling layer to be bypassed.

### BRIEF DESCRIPTION OF THE DRAWINGS

Further features and advantages will become apparent from the following description of preferred examples, given by way of example only, which is made with reference to the accompanying drawings in which like reference numerals are used to denote like features.

FIG. 1 is a schematic diagram illustrating a neural network according to an example;

FIG. 2 is a schematic diagram illustrating a convolutional layer according to an example;

FIG. 3 is a schematic diagram illustrating a strided layer according to an example;

FIG. 4 is a flow diagram illustrating a method according to an example;

FIG. 5 is a schematic diagram illustrating a composite kernel;

FIG. 6 is a flow diagram illustrating a method according to an example;

FIG. 7 is a schematic diagram illustrating a composite kernel being applied to an input feature map according to an example;

FIG. 8 is a schematic diagram illustrating an optimized neural network according to an example;

FIG. 9 is an apparatus diagram illustrating an apparatus suitable for implementing the methods described herein.

### DETAILED DESCRIPTION

Details of systems and methods according to examples will become apparent from the following description with reference to the Figures. In this description, for the purposes of explanation, numerous specific details of certain examples are set forth. Reference in the specification to ‘an example’ or similar language means that a feature, structure, or characteristic described in connection with the example is included in at least that one example but not necessarily in other examples. It should be further noted that certain examples are described schematically with certain features omitted and/or necessarily simplified for the ease of explanation and understanding of the concepts underlying the examples.

Certain examples described herein provide systems, methods and apparatuses for improving the computational efficiency of neural networks which comprise both computational layers and strided layers, such as pooling layers or a strided depthwise separable layer. Improving the computational efficiency, will reduce the amount of time to perform the necessary processing required to execute a neural network and reduce the associated energy consumption. Both of these factors may be particularly beneficial when seeking to implement neural networks in mobile devices.

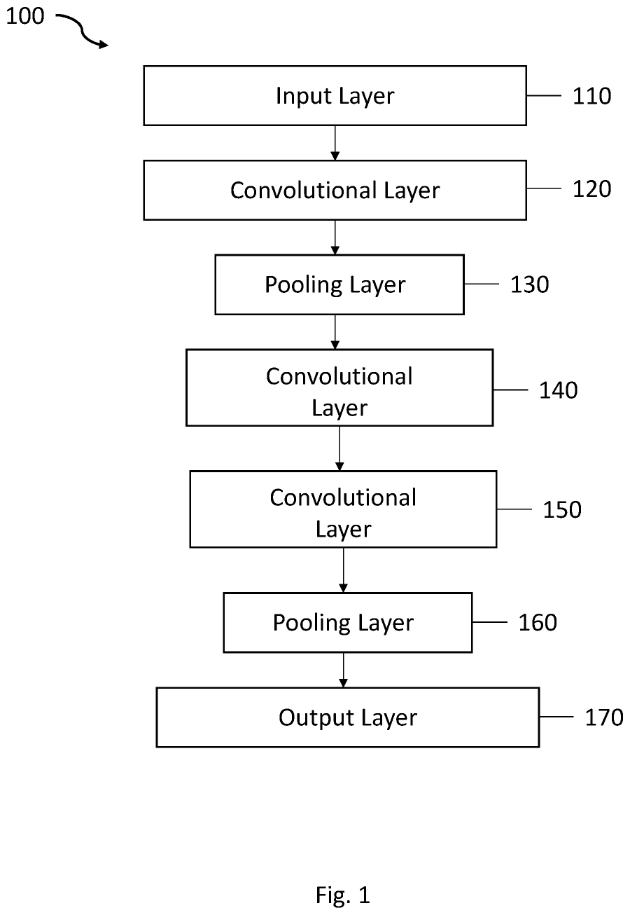

FIG. 1 schematically illustrates an example neural network 100 to which the methods described herein may be applied. In FIG. 1, a convolutional neural network has been shown. However, the methods described herein may be applied any other type neural network which comprises both computational layers and strided layers.

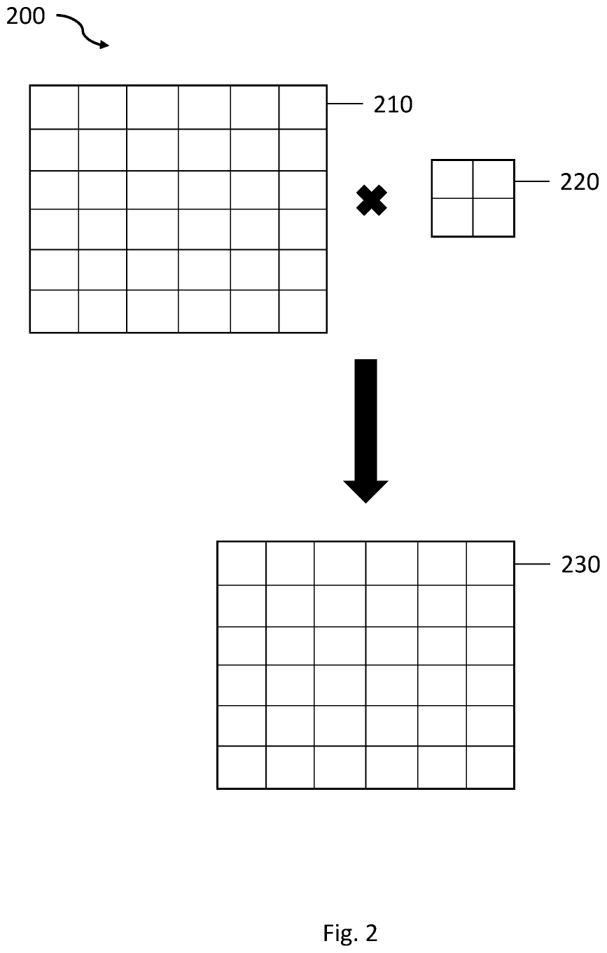

The neural network 100 comprises an input layer 110, three convolutional layers 120, 140, and 150, two strided layers which in this example are pooling layers 130 and 150, 160, and an output layer 170. The first convolutional layer receives data from an input layer 110, in the form of input data. The first convolutional layer 110 processes the received input data and outputs an output feature map to the first pooling layer 130. The function of the convolutional layers will be described in more detail below, in connection with FIG. 2.

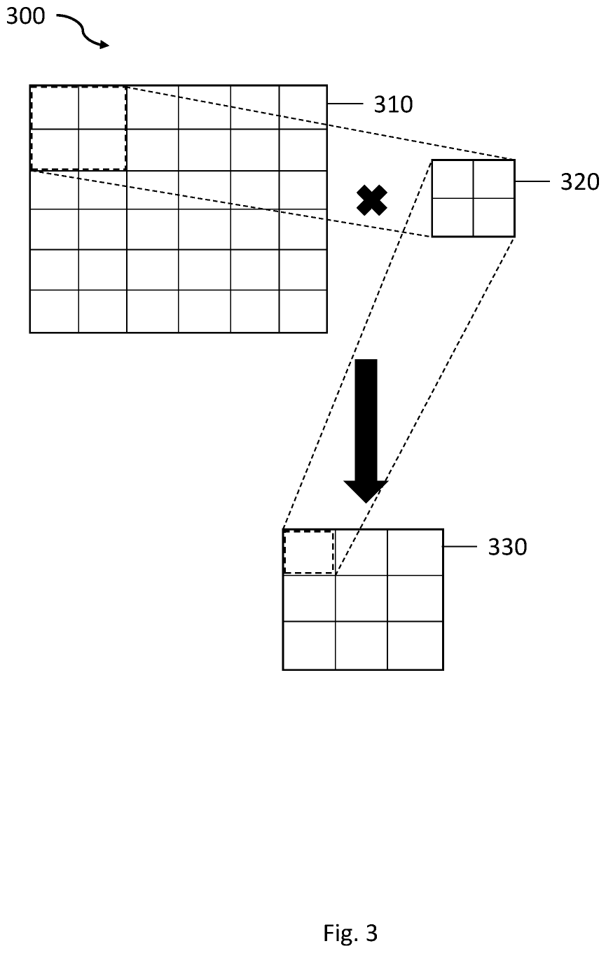

The first pooling layer 130 is a type of strided layer which operates on the feature map output from the first convolutional layer 120 to form a pooled output feature map, which is then fed to second convolutional layer 140. The function of the pooling layers 130 and 160 will be described in more detail below, in connection with FIG. 3.

The second convolutional layer 140 does not have an associated pooling layer. This arrangement is typical in many convolutional neural networks, where many of the convolutional layers operate on input feature maps, and then pass their output feature maps directly to further convolutional layers.

The third convolutional layer 150 receives data (in the form of a feature map) from the second convolutional layer 140. The third convolutional layer 150 processes the received data and outputs an output feature map to the second pooling layer 160, which again processes the data and produces a final output feature map which is passed to the output layer 170.

FIG. 1 thus represents a simple neural network with three convolutional layers. In practice, neural networks may comprise any number of layers, from a single processing layer to many hundreds of different processing layers. In addition, the neural network may comprise many different layer types, including fully connected layers and deconvolution layers. The methods described herein may be applied to neural networks with any number of layers. The level of advantage provided by the methods described is dependent on the number of strided pooling layers present in a neural network and the arrangement of each layer relative to other layers in the network. The presently described methods are particularly advantageous for large neural networks comprising many pooling layers. In the following description, the term advantage could refer to any of computational (processor) advantage, energy efficiency, processing throughput, processing latency or any other known improvement in computer processing techniques.

FIG. 2 schematically illustrates the operation of a convolutional layer 200, which exemplifies the function of each of convolutional layers 120, 140, and 150 of FIG. 1. A convolutional layer is a common building block of a convolutional neural network, the different functions of which would be well understood by the skilled person. For ease of understanding of the methods described herein, a convolutional layer is described in a simplified form below.

FIG. 2 illustrates an input feature map 210 represented as a 6×6 matrix. However, the input feature map 210 may be of any dimension. To produce the output feature map 230, a kernel 220 (otherwise known as a filter) is mathematically applied to the input feature map 210. The kernel 220 is convolved across the width and height of the input feature map 210 (hence the name “convolutional” layer), to compute the dot product between the values of the kernel 220 and the input feature map 210. These dot product values produce the output feature map 230.

The kernel 220 may be of any dimension. However, typically, a kernel will be of a smaller dimension than the input feature map, as the computational power required to convolve the kernel increases as the kernel size increases. Moreover, a kernel that is larger than its corresponding input feature map would increase the size of the subsequent output feature map, with no commensurate gain in the contained information. Kernels generally comprise values learned during training of the neural network, where the learned values have been found by the system to produce a particular output for a given input, including (for example) detecting lines, edges, features or performing any other function on a given input feature map.

Once the training phase of the neural network has been completed, the kernel 220 is typically considered to be a fixed operator, which only changes if the neural network is re-trained. The kernel 220 is stored in memory and retrieved when required by the neural network to process data passing through the network.

In FIG. 2, the input feature map 210 and the output feature map 230 have been illustrated in two dimensions (6×6). Whilst this is a valid example for very simple applications, in many Machine Learning applications the input feature map 210 and the output feature map 230 will have at least three dimensions, i.e. “6×6×2”, “6×6×3” . . . “6×6×N”. The methods described herein are applicable to data in any input and output format.

FIG. 3 schematically illustrates the operation of a pooling layer 200, which exemplifies the function of each of pooling layers 130 and 160 of FIG. 1. In this example, a 2×2 strided pooling operation is shown, although many different types of pooling operation are possible. A pooling layer is a common building block of a convolutional neural network, the different functions of which would be well understood by the skilled person. For ease of understanding of the methods described herein, a pooling layer is described in a simplified form below.

Pooling is a form of non-linear down-sampling which reduces the size of the input feature map. Intuitively, the exact location of a feature is less important than its rough location relative to other features. This is the idea behind the use of pooling in convolutional neural networks. The pooling layer serves to progressively reduce the spatial size of the representation, to reduce the number of parameters, memory footprint and amount of computation in the network, and hence to also control overfitting.

There are several non-linear functions that are commonly used to implement pooling. These functions include: 1) Max pooling, 2) Average pooling, and 3) Region of Interest pooling (a variant of Max pooling where the input rectangle is a parameter). In Max pooling, the input feature map is partitioned into a set of non-overlapping rectangles and, for each such rectangle, the maximum value is output as a representative value for the rectangle.

By contrast, Average pooling is where the average of the values is used, instead of the maximum value. Different Average pooling operators take the average of a different number of values—for example “2×2” Average pooling outputs the average (mean) of 4 values, whereas “3×3” Average pooling outputs the average value of 9 values. The following discussion will focus on the use of an Average pooling operator. However, the methods described herein may be applicable to different pooling operators.

Pooling functions are implemented using a kernel 320 which is applied to an input feature map 310 (which could be the output feature map of a preceding convolutional layer) in the pooling layer 300. The size of the output feature map 330 produced by the pooling layer 300, depends on several factors. The first factor is the size of the kernel providing the pooling function—a 2×2 pooling operator averages 4 values of the input feature map, whereas a 3×3 pooling operator averages 9 values. Thus, if applied without overlap to input feature map 310 (and without being applied to any boundaries of the input feature map), a “2×2” pooling operator would reduce the 6×6 input feature map to with a stride length of 2 would reduce the 6×6 input feature map to a 3×3 output feature map. Whereas, if applied without overlap, a “3×3” pooling operator would reduce the 6×6 input feature map to a 2×2 output feature map. The pooling operator need not necessarily have a square dimension indeed many different types of operators are possible such as 2×3, 2×4, 3×2 and so forth. Moreover, in practice, many pooling operators may have three dimensions, i.e. 2×2×N. For simplicity of understanding, a 2×2 operator will be referred to in the remaining description.

A further factor is the stride length performed when the kernel 320 is applied to the input feature map 310, during the convolution operation. The stride length is in simple terms, how far the kernel is moved between operations. For a 2×2 kernel, a stride length of 1 element would result in each application of the kernel partly overlapping the previous operation. Whereas a stride length of 2 elements would result in non-overlapping application of the kernel. The numbers used in the following description are correct for pooling kernels where the stride length is set to the pooling size. The skilled person would understand how to adjust these numbers for different stride lengths, and the examples described herein may be applied to kernels having any stride length. Similarly, the skilled person would understand how to apply such pooling operators to any depth of feature map (i.e. a three-dimensional feature map). It is also possible to apply this combined kernel to other strided layer types, as long as the strided layer provides a 1 to 1 mapping between its input feature map and the resultant output feature map, as is typical of a pooling layer or one half of a depthwise separable layer.

In the present example, a 2×2 strided average pooling operator is shown. The dashed lines shown in FIG. 3 illustrate the first operation, where 2×2 kernel 320 is applied to four elements of input feature map 310. The result of this first operation (i.e. the average of the four elements of input feature map surrounded by the dashed line), is used as the first element for the output feature map 330, as illustrated by the single element surrounded by a dashed line. As the pooling operation continues, kernel 320 would be strided 2 elements to the right and applied to four more elements of input feature map 310, calculating an average value for a further one element of the output feature map. In all, kernel 320 would be applied 9 times to input feature map 310, to produce the 9 elements of output feature map 330.

Typically, convolutional neural networks process data sequentially through the layers of the network (as shown in FIG. 1), with data processed at each layer by a kernel associated with that layer, before the output is passed to the next layer in the network. Methods herein seek to optimize how data is processed through the network. Specifically, to optimize how kernels are applied to data across layers of the neural network.

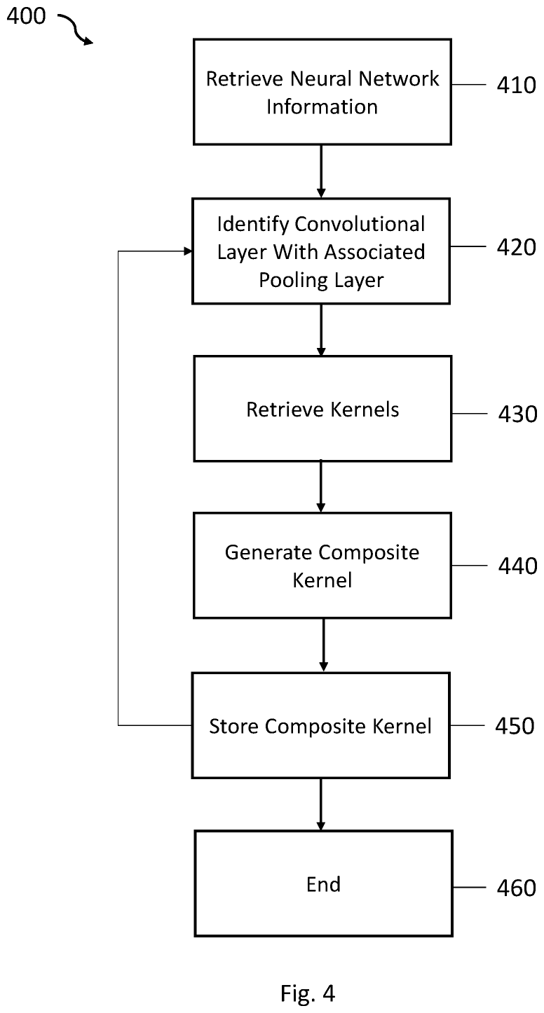

FIG. 4 is a flow chart 400 illustrating a method of optimizing machine learning processing in accordance with an example.

At a first step 410, neural network architecture information is retrieved, which is indicative of the architecture (i.e. layout and components) of a neural network to be processed by the methods described herein. The neural network architecture information comprises layer information indicative of the layers in the neural network, such as layer identifiers, which indicate the layer type (i.e. input, computational, output and so forth) and/or layer function (convolutional, fully connected, deconvolutional, recurrent, strided pooling and so forth). In some situations, it may also be helpful, but not essential, to know the activation function associated with a particular layer—the use of this activation function is explained in more detail in later examples. The neural network architecture information may also comprise kernel information, which is indicative of the size and/or function of the kernels associated with different layers in the neural network. In addition, the neural network architecture information may comprise the weights and biases of individual kernels. Moreover, the neural network architecture information may comprise activation function information for one or more layers of the neural network.

The neural network architecture information may also include any other information which helps describe or define the neural network, such as network size, network capacity, input information, output information, software configuration or expected hardware configuration. The neural network architecture information may also comprise information about the processor(s) that will be performing the neural network processing, including, for example: the size of the local memory (such as the processor'(s) buffers), whether the processor(s) support compression and if so do they support kernel and/or FM compression, what the typical compression ratios are, how efficiently the processor(s) can process different size kernels, and so forth. In some examples, some or all of the processor information may be retrieved from a different source to the neural network architecture information. Optionally, the processor information described above may be processed and stored separately from the neural network architecture information.

At step 420, the neural network architecture information is analyzed in order to identify convolutional layers with associated strided layers. Each convolutional layer and associated strided layer may be identified and processed simultaneously following the method below if sufficient processing capacity is available. However, for ease of understanding an iterative approach is described below, which may also be used. In the following examples, the associated strided layers will be referred to as pooling layers, for ease of understanding. However, the same analysis and processing steps can also be used to identify and process convolutional layers in the neural network which have other types of associated strided convolutional layers having a 1:1 mapping between input feature map layers, weight kernels and output feature map layers.

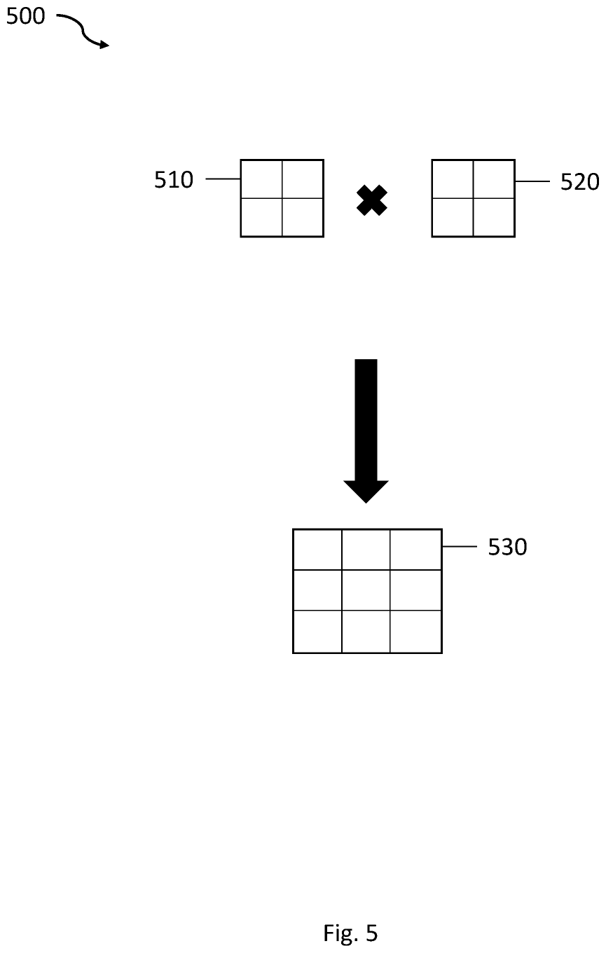

Once a convolutional layer and associated strided layer have been identified (such as convolutional layer 120 and associated pooling layer 130 shown in FIG. 1), at step 430 the kernels of the convolutional layer and the associated pooling layer are retrieved. Then, at step 440, a composite kernel is generated, based on the kernel of the convolutional layer and the associated pooling layer. The composite kernel will be explained in more detail below in relation to FIG. 5.

Once generated, the composite kernel may then be stored at step 450. The composite kernel may later be used in place of the kernels of the convolutional layer and the associated pooling layer—thereby enabling the function of the convolutional layers and the associated pooling layer to be applied to an input feature map in a single step.

Returning to method 400, if more convolutional layer/strided layer pairings are present, the method may return to step 420 and repeat method steps 430 to 450 until all convolutional layer/strided layer pairings, at which point the method ends at step 460. In this manner, the kernels of each convolutional layer/strided layer pair in the neural network may be replaced with composite kernels. In the example neural network of FIG. 1, this would result in two convolutional layer/strided layer pairings having their kernels composited—reducing the number of computational steps in the network 100 from 5 to 3.

The method in this example is agnostic to many factors, such as to the size of the input feature maps, the size of the output feature maps, how each layer is being processed, the size of the hardware performing the processing, the local memory size, whether the processor can process the composite kernel efficiently and so forth. One or more of these factors may be integrated into later examples, but none are essential to the present example. An optimized neural network created by this example could be compared to the original network to ensure an improved performance has been achieved. Both networks (optimized and original) could be executed by the available hardware and the best performing network retained and used thereafter (which may be dependent on what hardware is available). FIG. 5 schematically illustrates a composite kernel 530 formed from the combination of two kernels 510 and 520. Kernel 510 may be the kernel of a convolutional layer, such as kernel 220 in FIG. 2. Kernel 520 may be the kernel of a pooling layer, such as kernel 320 in FIG. 3.

The generated composite kernel 530 will be larger than either of the kernels 510, 520 from which it is formed. In use, this composite kernel will therefore require more space in the local memory of the processing unit when being applied to an input feature map, as compared to either of the original kernels 510, 520. Therefore, there is an extra memory overhead required to use the methods described herein. However, it has been recognized that in many modern neural networks, processing power is at more of a premium than memory. Thus, trading an increase in memory overhead for a reduction in the compute requirements is beneficial and enables data to be processed quicker and more effectively.

Each of the expected composite kernel size, the expected memory overhead and the expected compute reduction for a given composite kernel can be calculated in advance, as they are dependent on the size of the original input kernels. Optionally, the result of this calculation can be used to decide whether or not to generate and/or use a composite kernel in place of the original kernels of the convolutional and pooling layers. In the below table, example composite kernel sizes, memory overheads, and compute reductions have been calculated for four example combinations of convolutional kernel and pooling kernel:

| | Pooling | Composite | | |
|---|---|---|---|---|
| Convolutional | Kernel | Kernel | Memory | Compute |
| Kernel Size | Size | Size | Overhead | Reduction |
| 2 × 2 × N | 2 × 2 | 3 × 3 × N | 2.25× | 1.8× |
| 3 × 3 × N | 2 × 2 | 4 × 4 × N | 1.8× | 2.25× |
| 2 × 2 × N | 3 × 3 | 4 × 4 × N | 4× | 2.25× |
| 3 × 3 × N | 3 × 3 | 5 × 5 × N | 2.8× | 3.24× |

It can therefore be seen that for convolutional layer/strided layer pairings compute reductions in the region of approximately 1.8× to 3.24× can be achieved, with corresponding additional memory overhead (for the composite kernel as compared to the two input kernels) of between 1.8× and 4×. The calculations for determining composite kernels would be derivable by and understood by the skilled person. Example equations are set out below which define the calculations required for convolutional kernels with equal height and width (i.e. square kernels), with pooling kernels having equal height and width (i.e. square pooling), and where the stride length of the pooling kernel is equivalent to the size of the pooling kernel (the most common arrangement). Equation 1 defines composite kernel size “A”.

A=(H+h−1)×(W+w−1)×D Equation 1

Where the convolutional kernel I s defined as having a height “H”, a width “W” and a depth “D”. The pooling kernel is defined as having a height “h” and a width “w”. Similarly, the memory overhead for a given composite kernel can be calculated using equations 2 to 4 below, where equation 2 defines the memory requirement “B” for the convolutional kernel, equation 3 defines the memory requirement “C” for the composite kernel, and equation 4 defines the memory overhead “D”.

$$B = ( H \times W \times D ) \qquad Equation 2$$

$$C = ( H + h - 1 ) \times ( W + w - 1 ) \times D \qquad Equation 3$$

$$D = \frac{( ( H + h - 1 ) \times ( W + w - 1 ) \times D )}{( H \times W \times D )} \qquad Equation 4$$

The compute reductions can be calculated for a given composite kernel using equations 5 to 7 below, where equation 5 defines the compute requirement “E” for the pooling kernel and the convolutional kernel (expressed as the operations required to generate a single output feature map element), equation 6 defines the compute requirement “F” for the composite kernel, and equation 7 defines the compute reduction “G”.

$$E = ( H \times W \times D ) \times ( h \times w ) + ( h \times w ) \qquad Equation 5$$

$$F = ( H + h - 1 ) \times ( W + w - 1 ) \times D \qquad Equation 6$$

$$G = \frac{( ( H \times W \times D ) \times ( h \times w ) )}{( ( H + h - 1 ) \times ( W + w - 1 ) \times D )} \qquad Equation 7$$

In the above described methods, it has been presumed that the memory overhead increase caused by the use of a composite kernel is always acceptable due to the reduction in compute power required. Whilst in many modern networks sufficient local memory capacity is available making this assumption is correct, there are also systems where memory is more limited. Most systems will likely have significant memory capacity in one format or another (i.e. DDR-SDRAM), to be efficient. However, the size of “local memory” (i.e. each processor's buffer or cache) is what is important, as this is the memory which can be most quickly addressed (lower latency compared to accessing non-local memory), and it is this local memory which may be size limited. In addition to local memory generally having a low latency, the use of local memory is also advantageous as local memory generally has greater bandwidth and/or consumes less energy to access as compared to non-local memory. A further method will now be described which may be applied to systems which have memory restrictions. This further method enables each composite kernel to be assessed (either before generation or before storing) as to whether its advantages outweigh its memory downsides.

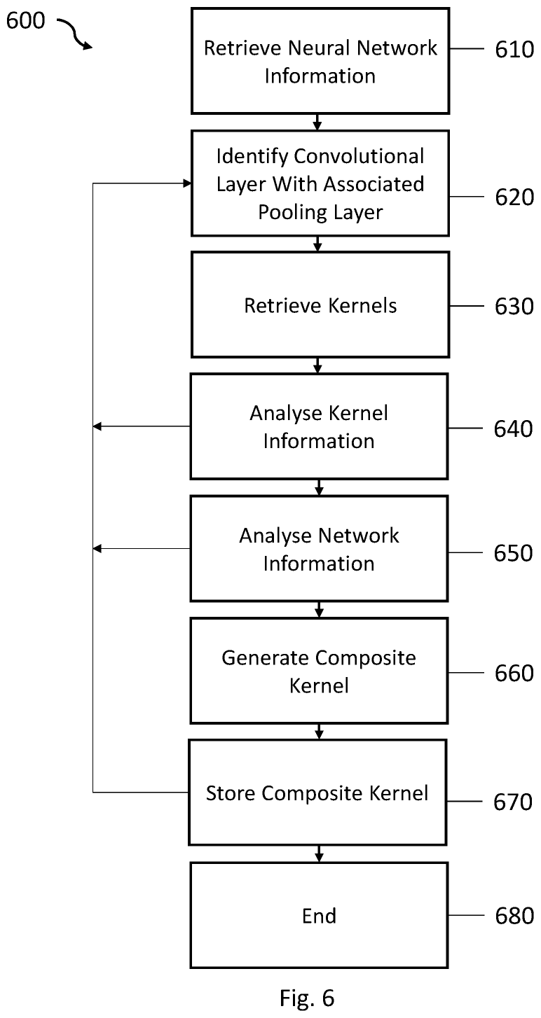

FIG. 6 illustrates this further method which may make use of the calculation of one or more of the composite kernel size, the memory overhead and the compute reduction to decide whether to generate and/or store a composite kernel, in accordance with an example.

As with the method described in reference to FIG. 4, at a first step 610, neural network architecture information is retrieved for a neural network to be processed by this method. The neural network architecture information may comprise layer information including layer identifiers, kernel information, and any other information which helps describe or define the neural network, such as activation functions, network size, network capacity, input information, output information, software configuration or hardware configuration.

At step 620, the Neural Network Information is analyzed in order to identify convolutional layers with associated strided layers. Each convolutional layer and associated strided layer may be identified and processed simultaneously following the method below. However, for ease of understanding an iterative approach is described below which may also be used.

Once a convolutional layer and associated strided layer have been identified (such as convolutional layer 120 and associated pooling layer 130 shown in FIG. 1), at step 630 the kernels of the convolutional layer and the associated pooling layer are retrieved.

Once the kernels have been retrieved, the method may optionally analyze the retrieved kernels (at step 640) of the convolutional layer and the associated pooling layer, in order to assess the properties of the retrieved kernels and/or the likely properties of a composite kernel generated from the retrieved kernels. This analysis may comprise calculation of the retrieved kernel size (if kernel size cannot be retrieved from the network architecture information) and/or calculation of the size of the composite kernel. Each kernel may be a two dimensional kernel (where calculation of the size is the width of the kernel multiplied by the height of the kernel) or a three dimensional kernel where calculation of the size is the width multiplied by the height multiplied by the depth of the kernel). In some examples, a particular layer may have multiple associated kernels, each of which can be combined using the methods described herein, and the size of multiple kernels calculated by further multiplying by the number of kernels (i.e. width×height×number, or width×height×depth×number).

Once calculated, these values may be compared against a threshold kernel size value. The threshold kernel size value setting either a minimum size value or a maximum size value. Kernels smaller than a minimum size value may be considered too small to warrant further processing and/or computationally simple enough to not warrant further processing. Conversely, kernels larger than a maximum size value may be considered to generate too great a memory overhead to warrant further processing. Either way, if further processing of the analyzed kernels is not warranted based on a threshold comparison, the method may return to step 620, to look for the next convolutional layer and associated strided layer pairing (where if no further pairings are found, the method may end).

If at step 640 the retrieved kernels do warrant further processing (or if step 630 has not been performed), the method may move on to step 650. In optional step 650 network information is retrieved and analyzed. This network information may be retrieved entirely from the original neural network architecture information, or it may be retrieved or supplemented with information from another network source. The network information may comprise memory information indicating the available memory capacity of the system(s) which will operate the neural network once optimized. The network information may also comprise information indicating the likely size of the input feature map to be processed by the retrieved kernels and/or the output feature map produced by the retrieved kernels.

At step 650 the memory information may be compared to the expected composite kernel size. If the expected composite kernel size is greater than the memory capacity, the method may stop and return step 620. Similarly, the expected composite kernel size plus the input feature map size may be compared with the memory capacity. If this combined size is greater than the memory capacity, the method may stop and return step 620. Additionally, the expected composite kernel size plus the input feature map size plus the output feature map size may be compared with the memory capacity. If this further combined size is greater than the memory capacity, the method may stop and return step 620.

Alternatively, or in addition, at step 650 the memory overhead may be calculated. The memory overhead may be a simple integer or non-integer value that represents the additional memory likely to be needed to process the composite kernel. The memory overhead may be compared to a predetermined threshold memory value and if found to be greater than said threshold, the method may stop and return to step 620. I.e. where a particular composite kernel is likely to have a memory overhead greater than a predetermined threshold, the method may stop and look for the next pairing.

Alternatively, or in addition, at step 650 the expected compute reduction associated with a composite kernel generated from the retrieved kernel may be calculated and compared to a predetermined compute threshold. If the compute reduction is found to be less than the compute threshold, which may indicate either zero or negligible compute reduction, the method may stop and return to step 620.

Optionally, when both expected memory overhead and expected compute reduction have been calculated, the two values may be compared to generate a benefit value indicative of whether the compute reduction outweighs the memory overhead gain. This benefit value may then be compared with a predetermined benefit value. If the benefit is negative or negligent, the method may stop and return to step 620.

Thus optional step 650 seeks to decide whether, if generated, the composite kernel would in use lead to a compute reduction (i.e. a reduction in the processing resources needed to perform the functions of the convolutional layer and the pooling layer) and/or if the associated memory overhead would cause an overflow of local memory which will be used in the network when processing the composite kernel. Whilst local memory overflows can be dealt with in neural network processing systems, the methods of dealing with an overflow (such as calling further data from external/static memory) often require more processing resources than would be saved through the use of the composite kernel. Moreover, needing to access non-local memory will likely result in higher energy consumption, and potentially reduced processing efficiency (due to the processor being stalled waiting on writing/reading memory). Therefore, spilling to non-local memory may result in higher energy consumption, and lower throughput. Hence, when negligible compute benefit is found and/or the memory overhead is too great, the composite kernel may not be generated (or may be discarded if already generated), and thus the convolutional layer and associated pooling layer would revert to being processed by their original kernels in use.

Alternatively, where it has been determined that one or both of the retrieved kernels comprise accumulated values that are likely to cause underflow or overflow in use (by for example comparing the accumulated value for each kernel with a threshold value indicative of a value which will cause underflow or overflow), the method may be further modified. For example, if one or both of the retrieved kernels comprise an accumulate value greater than the threshold value, instructions may be generated (and stored and/or transmitted) which cause the processor processing the associated composite kernel to saturate (i.e. perform saturate arithmetic/accumulation) said accumulate values when applying the composite kernel. Additionally or alternatively, if one or both of the retrieved kernels comprise an accumulate value greater than the threshold value, instructions may be generated (and stored and/or transmitted) which cause the processor processing the associated composite kernel to switch to a larger input data type when applying the composite kernel. Additionally or alternatively, if one or both of the retrieved kernels comprise an accumulate value greater than the threshold value, instructions may be generated (and stored and/or transmitted) which cause the processor processing the associated composite kernel to scale the values of the composite kernel by a predetermined factor, process an input feature map using the composite kernel's scaled values to produce an output feature map, and then re-scale the output feature map with the factor. Each of these optional method steps enable underflow and or overflow to be dealt whilst still using a composite kernel.

If one of the above described methods are followed and the benefit of generating a compute kernel has been shown, then, at step 660, a composite kernel may be generated, based on the kernel of the convolutional layer and the associated pooling layer. The composite kernel may be generated in accordance with any of the methods described herein.

Once generated, the composite kernel may then be stored at step 670. In one example, some or all of the information generated in steps 640 and 650 (when performed) may also be stored, either alongside the composite kernel or in separate memory. One advantage of storing the data relating to likely compute reductions and/or memory overhead is that it enables later analysis of the performance of the above described methods in optimizing the layers of a neural network. Alternatively, the generated information may be discarded.

The generated composite kernel may later be used in place of the kernels of the convolutional layer and the associated pooling layer, thereby enabling the function of both layers to be simultaneously applied to the input feature map supplied to the convolutional layer.

After storing the generated composite kernel, the method may then check for the presence of further convolutional layer/strided layer pairings, by return to step 620 and thereafter repeating method steps 630 to 670 until all convolutional layer/strided layer pairings have been identified and processed, at which point the method ends at step 680. In this manner, some or all of the kernels of each convolutional layer/strided layer pair in the neural network may be replaced with composite kernels. Consequently, a significant compute reduction may be achieved by implementing the methods described herein, with the level of compute reduction being dependent on the number of convolutional layer/strided layer pairings in the network, and the computational capabilities of the system(s) which will ultimately implement the neural network.

The examples described herein assume that the entirety of the processor's local memory is available for locally storing the data required to implement the presently described methods (i.e. for local storage of one or more kernels, input feature maps, output feature maps and/or other neural network architecture information). However, in some examples, local memory may be required to store other unrelated data (such as other feature maps, or other processing data), meaning that only a portion of the local memory is available. In such examples, the reduced available memory size should be considered to be the available memory size.

In addition to the size of the available local memory and/or compute reduction, the expected bandwidth of the system performing the method steps described herein may be taken into account when deciding whether or not to generate and/or implement a composite kernel. In systems with limited bandwidth, the time taken to transfer the necessary data for processing from external memory to local memory may be greater than the time necessary to process said data in accordance with the methods described herein. In such cases, it may be preferable to not process data for layers where the transfer time exceeds a transfer time threshold.

In addition, certain processors may be optimized for processing kernels of certain dimensions, and less efficient at processing kernels of other dimensions. For example, a processor may be optimized to process kernels of a certain dimension or smaller, such as 5×5×N kernels. In further examples, the methods described herein may compare the expected size of a generated composite kernel to the size of kernel a particular processor in the system is optimized to process. In such examples, a composite kernel may be either not generated or not stored if the size of the composite kernel is greater than the kernel size said particular processor is optimized to process, or is greater than a threshold kernel size above which the processor cannot efficiently process said composite kernel. For example, if a processor is optimized to process kernels up to a size of 5×5×N, then a composite kernel of size 6×6×N may be not generated or discarded as it may be less efficient to process such a large composite kernel compared to the original kernels forming the composite kernel.

A worked example illustrating typical values for a neural network will now be described, to illustrate the potential memory overhead that may be introduced and compute resource improvements that may be realized by following one or more of the examples described herein.

Consider a convolutional layer expected to receive an input feature map of 300×300×8 input elements, and which when processed by the convolutional layer produces an output feature map of 100×100×32 elements (where processing by the convolutional layer comprises a change in the dimensionality of the data). To process this input feature map, the convolutional layer convolves the input feature map with more than one kernel, as may often be the case in real-world applications. In this example, the convolutional layer is arranged to convolve the input feature map with 32 kernels each of size 3×3×8, in order to produce the output feature map. The convolutional layer also has an associated strided layer, in this example an average pooling layer. The pooling layer is arranged to apply a 3×3 pooling kernel to the output of the convolutional layer.

Ideally, in use, the input feature map, the generated output feature map and the kernel(s) for a specific layer would be stored in local memory associated with the processor implementing the neural network, which may be the on-chip buffer of a processing unit, which may be a neural processing unit (NPU). To understand if this is achievable for a given local memory size, data sizes can be calculated and compared to the local memory size. First, data sizes for the convolutional layer without any composite kernel optimization can be calculated as follows:
Local memory size (retrieved from network information): 1020 kB
Input Feature Map size: 300×300×8=720,000 elements/1024 bytes in a kB=703.125 kB
Output Feature Map size: 100×100×32=320,000 elements/1024 bytes in a kB=312.5 kB
Convolutional Layer Kernel size: 3×3×8×32=2304 elements/1024 bytes in a kB=2.25 kB
Total data size=703.125 kB+312.5 kB+2.25 kB=1017.875 kB

Thus, in the above example, each of the input feature map, the output feature map and the convolutional layer kernels can be held in local memory of size 1020 kB. In an un-optimized neural network, this is the maximum amount of data likely to be needed in local memory at any one time, as each layer (convolutional or pooling layer) are effectively processed independently. Next, consider a neural network optimized by a method described herein in which the memory overhead caused by the use of a composite kernel must now be taken into account. The composite kernel is arranged to perform the function of the 32 convolutional layer kernels and the 3×3 pooling layer kernel, and thus a new total data size must be calculated:
Convolutional Layer Kernel Size=3×3×8(×32)
Pooling Layer Kernel Size=3×3
Composite Kernel Size=5×5×8(×32)=6400 elements/1024 bytes in a kB=6.25 kB
Total data size with Composite Kernel=703.125 kB+312.5 kB+6.25 kB=1021.875 kB

Therefore, if composite kernel optimization is used in this example, the total data size of 1021.875 kB would not fit in the local memory of 1020 kB, leading to data needing to be spilled from the local memory (most likely the output feature map). Hence, to use the composite kernel in this example, the output feature map would have to be written to memory rather than held in local memory, requiring an additional 312.5 kB of data to be written to memory. Moreover, the next layer in the neural network would then need to retrieve this data from the memory in order to process it at the next layer, meaning the same 312.5 kB would have to then be read from memory. Thus, even a small mismatch in data size and local memory size can cause significant additional requirements to write/read data from external memory, which may result in lower processor efficiency, and is potentially slow, power hungry, and wasteful of system bandwidth. Hence, in this example, it may be preferable not to use the composite kernel, in accordance with some of the examples set out above.

By contrast, the following layers of the neural network will be processing data of a smaller size, as the pooling layer described in the example will downsize the output feature map. Thus in following layers, it is unlikely that the total data size when including the composite kernel will be larger than the local memory size, and thus there is no likely local memory overspill which would outweigh the compute reduction benefits, which as set out above, could provide a 3.24× compute reduction for this example. Therefore, in further layers it would be beneficial to generate and apply the composite kernel. Similarly, if a processing unit with a larger local memory size is available, processing this layer with a composite kernel may be preferable.

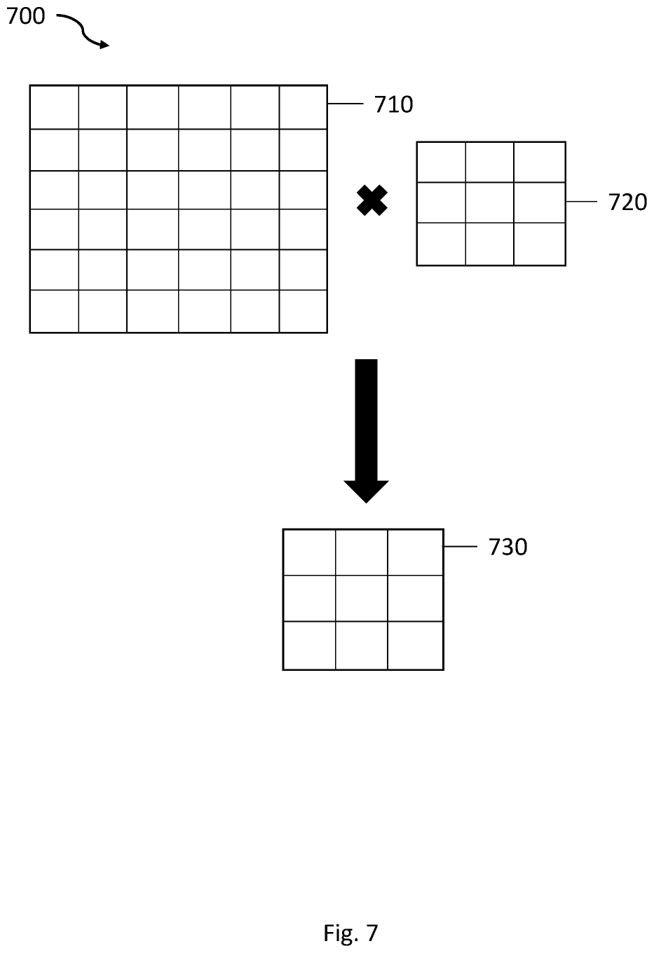

Examples of methods of applying a composite kernel to an input feature map will now be described in reference to FIG. 7. FIG. 7 schematically illustrates an input feature map 710 which is to be processed (i.e. convolved) with composite kernel 720. Composite kernel 720 may have been formed in accordance with any of the examples provided herein. When composite kernel 720 is applied to composite kernel 710, output feature map 730 is produced. The composite kernel 720 may be applied as a standard strided convolution, in the same manner as was explained in connection with FIG. 3, using any suitable method known in the art. The stride length of the composite kernel is the same length as the original strided layer. In this manner, input feature map 710 has at least two mathematical operations performed on it by the composite kernel 720, which for example could be both a convolutional layer process (causing a data transformation) and a strided pooling process (causing data down-sampling). When the composite kernel 720 is applied to the input feature map 710, the composite kernel is strided across the input feature map 710 in the same manner a pooling operator would normally be applied, in this way, both of the original mathematical operations can be simultaneously applied to the input feature map 710.

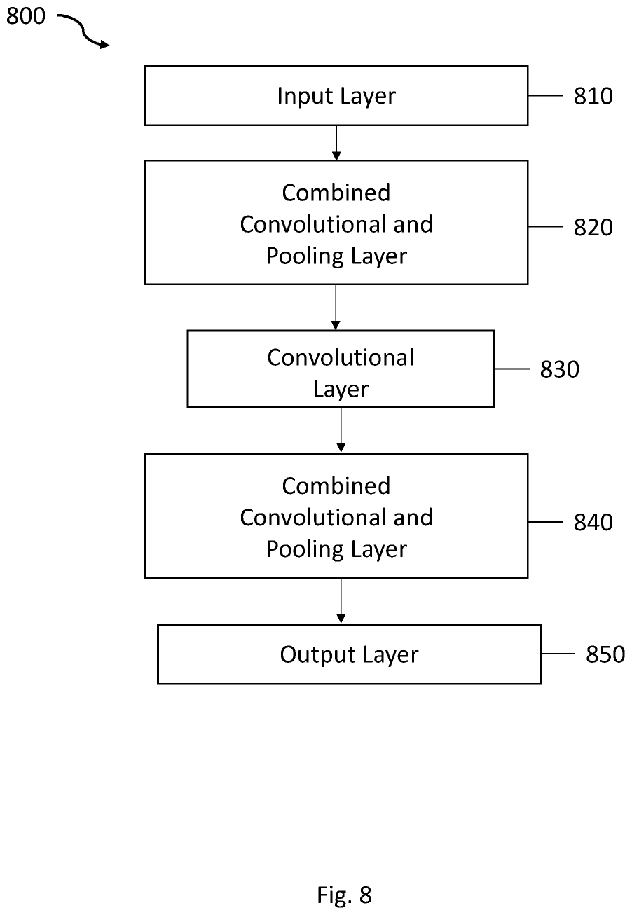

An example of how the above described methods may be applied to a neural network will now be described in reference to FIG. 8, which helps to illustrate the benefits of applying the methods described herein to a neural network.

FIG. 8 is a schematic diagram of an optimized neural network 800. Optimized neural network 800 corresponds to neural network 100 of FIG. 1 which has been optimized by one or more of the methods described herein. Optimized neural network 800 comprises an input layer 810, an output layer 850, a convolutional layer 830, and two combined convolutional and pooling layers 820 and 840.

The original neural network (as shown in FIG. 1) comprised three convolutional layers, two of which had associated pooling layers. Optimized neural network 800 is shown as having two fewer layers in comparison to the neural network of FIG. 1, as the two convolutional layers with associated pooling layers have each been optimized such that their respective kernels have been combined to form two composite kernels. In use, each composite kernel can be applied to input data (which may be in the form of an input feature map), wherein the composite kernel will apply both the operations associated with one of the original convolutional layers and the operations of the convolutional layer's associated pooling layer. Hence, through the use of composite kernels, the neural network can be simplified by effectively introducing layers which apply both a convolution function and a pooling function, which are labelled in FIG. 8 as “combined convolutional and pooling” layers.

Thus in comparison to neural network 100, optimized neural network 800 performs two fewer mathematical processing steps (as two fewer kernels are used), which can lead to a significant reduction in compute resources to process an input feature map through the neural network.

In each of the examples described herein, each layer of the neural network may or may not have an activation function. If a given layer does not have an activation function, or if the layer uses an identity activation function, the output produced by the composite kernel when applied to an input feature map will be the same as would be produced by the normal processing methods of using the computational layer's kernel followed by the strided layer's kernel.

However, if a layer uses a non-identity activation function, the output feature map may differ from that which would be produced by the original kernels. For many activation functions, such as identity, logistic, sigmoid, ReLU, or softplus activation functions, the output feature map generated by the composite kernel will be close to or the same as the output feature map which would be produced by the original kernels. In such cases, it is likely not worth making any changes to the above described methods as any differences may be negligible. However, there are ways of coping with these changes, which could be applied to the above described methods. These methods may be particularly useful when using activation functions likely to produce more divergent results, for example, non-monotonic activation functions (such as GELU, SIL, gaussian). Similarly, some activation functions that generate negative results (such tanh, elu, leaky ReLU, PReLU, softsign, SQNL, bent identity) may also produce divergent results.

A first method of dealing with this divergence is to perform further method steps to analyze the level of divergence. This would involve generating the composite kernel by one of the methods described above, and then processing an example input feature map both with the original kernels and the composite kernel. The two output feature maps may then be compared to quantify the divergence between the two. In some examples, this level of divergence may be compared to a threshold divergence level, and the composite kernel discarded if the level of divergence is too high. Where a composite kernel is discarded, the original layer kernels may be used in its place, to enable the network to still be implemented. This method step may be applied once to a single layer or incorporated as part of the general neural network optimization method as needed.

A second method to deal with this divergence is to use the adaptive capabilities of neural networks to nullify the effect of any divergence. In other words, the neural network could be re-trained with the generated composite kernel(s) until the output of the neural network is the same or sufficiently similar to the original un-optimized neural network. In this manner, the compute benefits may still be realized and the neural network output unaffected, although there would be an additional training overhead.

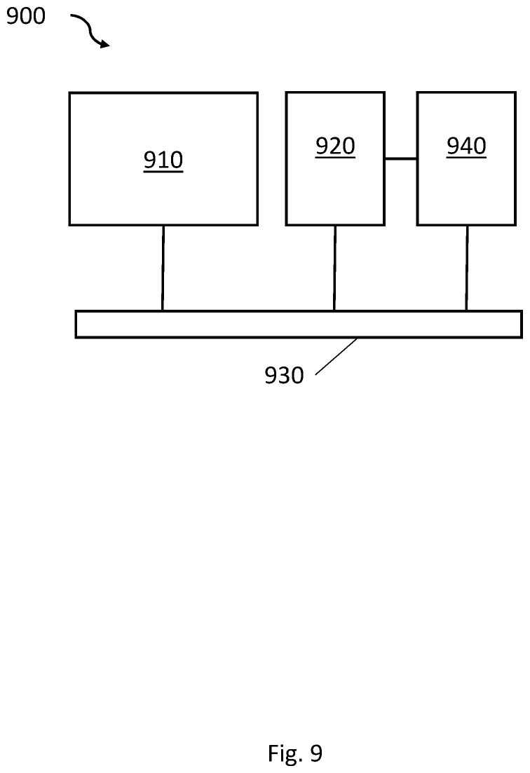

An example of a neural network driver apparatus 900 for use with the methods described herein is shown schematically in FIG. 9. The neural network driver 900 of FIG. 9 may be coupled to or form part of a computer device, such as a personal computer, a laptop, a smartphone, a server or a cloud computing environment.

The neural network driver 900 includes an input 910. Input 910 may be a wired or wireless connection suitable for receiving input data from an external source. Input 910 may be used to receive and/or fetch any of the data referred to in this description, such as neural network architecture information, layer information, layer data, kernel information, kernel data, network information and so on. The input 910 may be further arranged to output data, such as composite kernels, to external storage (not shown). Alternatively, a dedicated output may be provided.

Input 910 is arranged to send input data to one or more processors 920 via a common systems bus 930. Processor 920 may be used to optimize one or more neural networks using one or more of the methods described above. In other examples, though, the neural network driver 900 may include other or alternative processors such as a microprocessor, a general purpose processor, a digital signal processor (DSP), an application specific integrated circuit (ASIC), a field programmable gate array (FPGA) or other programmable logic device, a discrete gate or transistor logic, discrete hardware components, or any suitable combination thereof designed to perform the functions described herein. The neural network driver 900 may also or alternatively include a processor implemented as a combination of computing devices, e.g., a combination of a DSP and a microprocessor, a plurality of microprocessors, one or more microprocessors in conjunction with a DSP core, or any other such configuration. The neural network driver 900 may also or alternatively include at least one graphics processing unit (GPU).

Processor 920 may be a neural processing unit (NPU), and additionally or alternatively the neural network driver 900 may be further arranged to implement the neural network. An NPU is a processor designed to implement a convolutional neural network and may also be referred to as a neural network accelerator (NNA), a convolutional neural network accelerator (CNNA), a machine learning accelerator (MLA), or an artificial intelligence accelerator (AIA). An NPU includes an array of specialized convolution engines (CEs), which each contain for example multiply-accumulate (MAC) hardware to perform convolutional operations. The methods described herein may be executed in parallel by multiple processors, of any suitable type, such as one or more homogenous or heterogenous multi-core processors. Moreover, different processor types may be used to execute different parts of the methods described herein. For example, any processor type may be used to generate composite kernels, whilst more specialized processors (such as a neural processing unit, a graphical processing unit, a DSP or an FPGA) may be used for later processing of the neural network,

The neural network driver 900 of FIG. 9 also includes 1040.local memory 940, such as a buffer or cache. The local memory 940 may be, for example, external to the processor 920. The local memory 940 may be or include a non-volatile memory such as Read Only Memory (ROM) or a solid-state drive (SSD) such as Flash memory. The local memory 940 in examples may include further storage devices, for example magnetic, optical or tape media, compact disc (CD), digital versatile disc (DVD) or other data storage media. The local memory 940 may be removable or non-removable from the neural network driver 900. The local memory 940 is for example arranged to store input data received from input 910.

The components of the neural network driver 900 in the example of FIG. 9 are interconnected using a common systems bus 930. This allows data to be transferred between the various components. The bus 930 may be, or include, any suitable interface or bus. For example, an ARM® Advanced Microcontroller Bus Architecture (AMBA®) interface, such as the Advanced eXtensible Interface (AXI), may be used.

Certain examples described herein provide methods for processing input data using a neural network split into layers, including the use of one or more composite kernels. When implementing at least one layer of a convolutional neural network, such as a convolution and/or deconvolution layer, network memory access may be performed for a variety of data. Convolution layers read input data as an input feature map (IFM) and output processed data as an output feature map (OFM). Examples described herein may apply to accessing portions of memory when reading and/or writing input data, output data, data relating to the convolutional neural network such as data representing weights of kernels in at least one layer of the convolutional neural network, and/or bias data. Input data may relate to data input to a first layer of the convolutional neural network and data which is input to each subsequent layer of the convolutional neural network. Input data may include sensor data derived from one or more sensors such as image sensors, sound sensors, and other suitable forms of sensor data as described below. as described below. Input data may also comprise pre-recorded material such as audio, visual or audio/visual data (corresponding for example to television shows, films or music), or live material received over a network, such a video conferencing data or like video/audio recordings. Input data may also include input feature maps, generated from performing operations on sensor data. In some examples, data input to a first layer of a convolutional neural network maybe sensor data and data input to subsequent layers of the convolutional neural network may be referred to as input feature maps. Output data may relate to data output from a last layer of the convolutional neural network and data which is output when performing convolutions at each intermediate layer. Data which is output when implementing a convolutional layer on an IFM or input data from a sensor may be referred to as one or more OFM. The data may be compressed or uncompressed.

The neural network receives input data, weights, and biases such as in the form of an input feature map for a convolutional neural network layer, and each layer of the neural network outputs output data, such as an output feature map for a convolutional neural network layer. The output data of each layer is then provided as an input into the next layer for further processing. In some examples, the entirety of each layer's output will fit within the on-chip local memory of a processor, such as a neural processing unit (NPU), central processing unit (CPU) or graphics processing unit (GPU). However, in other examples, the capacity of the on-chip local memory may not be capable of storing all the output data of the layer. In such examples, there are several options for overcoming this limitation, some of which are described above.

The above examples have illustrated the computational benefits which can be achieved in neural networks comprising computational layers and associated strided layers, generally using average pooling layers as examples. Computational benefits can also be achieved in other neural networks which comprise computational layers and strided depthwise separable layers (either in conjunction with or in the absence of the presence of pooling layers).

The above examples are to be understood as illustrative examples of the present disclosure. Further examples are envisaged. It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the disclosure, which is defined in the accompanying claims.

What is claimed is:

1. A method for optimising machine learning processing, comprising
retrieving, neural network architecture information for a neural network, the neural network architecture information comprising layer information and kernel information for the neural network;
analysing the neural network architecture information to identify convolutional layers in the neural network which have associated strided pooling layers;
retrieving a first kernel for a convolutional layer identified as having an associated strided pooling layer;
retrieving a second kernel for the strided pooling layer associated with the convolutional layer;
generating a composite kernel, based on the first and second kernel, that performs the functions of the first and second kernel; and
storing the composite kernel.

2. The method of claim 1, further comprising:
retrieving local memory size information for a processing unit of the neural network;
calculating the size of the composite kernel;
comparing the size of the composite kernel with the local memory size; and
only generating the composite kernel if the composite kernel size is less than or equal to the local memory size.

3. The method of claim 2, further comprising:
retrieving the expected size of an input feature map to be provided to the convolutional layer;
calculating the total size of the composite kernel and the input feature map;
comparing the total size of the composite kernel and the input feature map with the local memory size; and
only generating the composite kernel if the total size of the composite kernel and the input feature map is less than or equal to the local memory size.

4. The method of claim 3, further comprising:
retrieving the expected size of an output feature map produced by the convolutional layer;
calculating the total size of the composite kernel, the input feature map and the output feature map;
comparing the total size of the composite kernel, the input feature map and the output feature map with the local memory size; and
only generating the composite kernel if the total size of the composite kernel, the input feature map and the output feature map is less than or equal to the local memory size.

5. The method of claim 2 further comprising:
retrieving the expected size of an output feature map produced by the convolutional layer;
calculating the total size of the composite kernel and the output feature map;
comparing the total size of the composite kernel and the output feature map with the local memory size; and
only generating the composite kernel if the total size of the composite kernel and the output feature map is less than or equal to the local memory size.

6. The method of claim 1, further comprising:
determining the advantage of using the composite kernel over the use of the first and second kernel; and
only generating the composite kernel if the advantage is greater than a predetermined threshold.

7. The method of claim 1, wherein the strided pooling layers are average pooling layers and/or strided depthwise separable layers.

8. The method of claim 1, wherein the neural network is a convolutional neural network.

9. The method of claim 1, further comprising the steps of:
determining if either of the first or second kernel comprise accumulated values that are larger than a threshold value, wherein the threshold value is indicative of a value which will cause underflow or overflow.

10. The method of claim 9, further comprising:
if one or more values are greater than the predetermined threshold, generating instructions to saturate said values when applying the composite kernel; and
storing said instructions with the composite kernel.

11. The method of claim 9, further comprising:
if one or more values are greater than the predetermined threshold, generating instructions to switch to a larger input data type when applying the composite kernel; and
storing said instructions with the composite kernel.

12. The method of claim 9, further comprising:
if one or more values are greater than the predetermined threshold, generating instructions to:
scale the values of the composite kernel by a factor,
process an input feature map using the composite kernel's scaled values to produce an output feature map;
re-scale the output feature map with the factor; and
storing said instructions with the composite kernel.

13. The method of claim 12, wherein the factor is either predetermined or calculated based on the change in value required to avoid underflow or overflow.

14. The method of claim 1, further comprising:
retrieving one or more additional kernels for the convolutional layer; and
generating the composite kernel based on the first kernel, the second kernel and the one or more additional kernels, the composite kernel adapted to perform the functions of each kernel it is based on.

15. The method of claim 1, further comprising:
identifying, based on the neural network architecture information, an activation function associated with the convolutional layer identified as having an associated strided pooling layer; and
if said activation function is a non-identity activation function, determine the divergence between an output feature map produced by applying the composite kernel and an output feature map produced by applying the first and second kernel.

16. The method of claim 15, wherein if the determined divergence is greater than a predetermined divergence threshold, the composite kernel is discarded.

17. The method of claim 15, wherein if the determined divergence is greater than a predetermined divergence threshold, the method further comprises generating instructions to retrain the neural network to reduce the divergence below the predetermined threshold.

18. A non-transitory computer-readable storage medium comprising a set of computer-readable instructions stored thereon, which when executed by at least one processor, cause the at least one processor to perform the steps of claim 1.

19. A neural network driver comprising:
a processor; and
memory storing computer readable instructions which, when implemented by the processor, cause the processor to perform the steps of claim 1.

20. A neural network comprising:
a convolutional layer arranged to receive an input feature map and perform a first operation on the received input feature map;
a strided pooling layer arranged to receive an output of the convolutional layer and perform a second operation on the received output; and
a composite kernel, which, when used to process the input feature map received by the convolutional layer, performs both the first and second operation on the input feature map, thereby enabling the strided pooling layer to be bypassed.
